(19) United States
(12) Patent Application Publication
(10) Pub. No.: US 2008/0144125 A1
(43) Pub. Date: Jun. 19, 2008

(54) Image processing apparatus

(75) Inventors: Yuji Okamoto, Kyoto (JP); Shuhji Fujii, Kyoto (JP); Nobuyuki Ueda, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/002,638

(22) Filed: Dec. 18, 2007

(30) Foreign Application Priority Data
Dec. 18, 2006 (JP) 2006-340059

(51) Int. Cl. H04N 1/387

(52) U.S. Cl. 358/453

(57) ABSTRACT

When a specific image is detected in inputted image data, specific image judgment is performed in consideration of the importance degree of this specific image, and thereby, the accuracy of the specific image judgment is improved, and misjudgment is prevented. There are provided a detection section 70 for detecting a specific image in inputted image data, a judgment section 71 for judging whether specific images are included in the image data on the basis of a threshold, and a threshold determination section 65 for recognizing the characteristics of the detected specific image and determining the threshold according to the characteristics. The characteristics of the specific image are changed according to the importance degree of the specific image. The threshold determination section 65 judges the importance degree from the characteristics of the detected specific image. When the threshold is the number of specific images, the threshold determination section 65 decreases the threshold in the case where the importance degree is high and increases the threshold in the case where the importance degree is low.

### BACKGROUND OF THE INVENTION

1. Field of the Invention

The present invention relates to an image processing apparatus which restricts processings such as copying, facsimile communication and data transmission on the basis of specific images included in image data.

2. Description of the Related Art

An image processing apparatus executes processing of inputting image data and outputting it by copying, facsimile communication or data transmission. Specific images are added to the image data in order to prevent leakage of the data by unauthorized use of the data. When it is judged that the specific images are included in the inputted image data, the processing to be executed is restricted. For example, the processing is inhibited.

Addition of the specific images is performed so that multiple specific images are included in image data corresponding to one page. The image processing apparatus reads a document to which the specific images are added and detects the specific images from the inputted image data. In this case, the number of specific images is counted in order to certainly judge that the specific images are included. When the number of specific images exceeds a threshold, it is judged that the specific images exist, and restriction of processing is performed.

For example, in Japanese Patent Laid-Open No. 2001-94771, a threshold for identifying a specific image for paper money, securities or the like is set for each kind of image data, such as copy data, facsimile data and printer data. When it is detected that the specific images are included in inputted image data, printing of the image data is inhibited. In Japanese Patent Laid-Open No. 7-123254, when it is recognized that a specific image repeatedly appears in the image data of a document, the output state of an image to be outputted is changed.

As described above, the specific images are added and outputted by being synthesized with image data. Then, in order to judge whether the specific images exist or not, detection of the specific images from the synthesized images is performed. In this case, if images in a form similar to the form of the specific images exist in the image data, the detection of the specific images is influenced thereby. For example, there is a possibility that a specific image is hidden among or overlapped with the similar images and is not detected. As a result, the number of detected specific images does not exceed a threshold, and restriction of processing is not performed though the restriction should be performed. On the contrary, if a similar image is misdetected as a specific image, the number of specific images exceeds the threshold. As a result, processing is restricted though the restriction is not necessary, which is inconvenient for a user.

In order to prevent such misdetection, it is common to assume that the specific image is a specific image having characteristics different from the characteristics predetermined as the characteristics of image data to be inputted, and add this specific image. Thereby, it is possible to distinguish the specific image from similar images and detect only the specific image without fail.

In the case of tightening the restriction of processing, the importance degree of the specific image is increased. In the case of loosening the restriction, the importance degree of the specific image is lowered. Then, the characteristics of the specific image are determined according to the importance degree of the specific image. Thus, when a specific image is added, the importance degree of the specific image is taken into account.

When a specific image is detected, it is judged whether or not the number of specific images exceeds a preset threshold. The importance degree of the specific image is not taken into account at all. That is, the threshold is constant irrespective of the importance degree of the specific image. Therefore, though it is possible to judge the existence of a specific image accurately when the importance degree is high, it is also judged that a specific image exists even when the importance degree is low. On the contrary, it may occur that, though the importance degree is high, a misjudgment is made that a specific image does not exist, and processing is not restricted.

In view of the above problem, the object of the present invention is to provide an image processing apparatus which, when detecting a specific image in inputted image data, takes the importance degree of the specific image into account to improve the accuracy of specific image judgment and prevent misjudgment.

### SUMMARY OF THE INVENTION

The present invention is provided with a detection section for detecting a specific image in inputted image data; a judgment section for judging whether the specific image is included in the image data on the basis of a threshold; a threshold determination section for recognizing the characteristics of the detected specific image and determining the threshold according to the characteristics.

Specific images added to image data are not uniform in order to avoid influence of an image in the image data or to enhance the detection accuracy. Therefore, the specific images have a variety of characteristics. When detecting such a specific image, the detection section extracts the characteristics of the specific image. Thereby, the threshold determination section can recognize the characteristics of the specific image. Then, the threshold determination section determines a threshold in consideration of the characteristics of the specific image so that specific image judgment can be performed accurately.

The characteristics of the specific image are changed according to the importance degree of the specific image. By recognizing the characteristics of the specific image, the importance degree of the specific image is known. The threshold determination section determines a threshold according to the importance degree. When the threshold is the number of specific images, a small value is set as the threshold in the case where the importance degree is high, and a large value is set as the threshold in the case where the importance degree is low.

When processing of the image data is restricted on the basis of the result of the specific image judgment, the importance degree is determined according to the degree of restriction of the processing. When the importance degree is high, the restriction of the processing must be performed without fail. When the importance degree is high, it is possible to, by setting a small value as the threshold, correctly judge that a specific image is included and restrict the processing without fail. When the importance degree is low, it is possible to, by setting a large value as the threshold, judge that a specific image is not included even if an image similar to the specific image is detected, and it is possible to prevent unnecessary restriction of the processing due to misjudgment.

The specific image is in a form having a predetermined angle, size or density. The specific image can be characterized by changing the angle, the size or the density. Specifically, the specific image is an inclined linear image. The angle of inclination, the thickness or the density can be changed according to the importance degree.

The threshold determination section changes the threshold on the basis of the degree in change of the characteristics of a detected specific image relative to the characteristic of a reference specific image. In the case where a reference threshold is set in advance, the threshold determination section changes the threshold to determine a new threshold. In this case, the set threshold is increased or decreased on the basis of the degree of change in the characteristics of the specific image.

When the threshold is the number of specific images, the threshold is set lower as the importance degree of the specific image is higher, and it is set higher as the importance degree of the specific image is lower. The threshold determination section increases or decreases the threshold according to the change degree. As the change degree is larger, the change in the threshold is larger.

According to the present invention, by determining a threshold on the basis of the importance degree of a specific image, which is determined according to the degree of restriction of processing of image data, the accuracy of specific image-judgment is enhanced, and restriction of processing can be executed without fail, in the case of a high importance degree. On the other hand, in the case of a low importance degree, misjudgment due to the existence of a similar image is eliminated, and it is possible to prevent unnecessary restriction of processing.

### BRIEF DESCRIPTION OF THE DRAWINGS

FIG. 1 is a control block diagram of an image processing apparatus of the present invention;

FIG. 2 is a diagram showing the schematic whole configuration of the image processing apparatus;

FIG. 3 is a diagram showing a document in which specific images are arranged and an enlarged specific image;

FIG. 4 is a diagram showing a security setting screen;

FIG. 5 is a diagram showing specific images with different angles;

FIG. 6 is a diagram showing specific images in different densities; and

FIG. 7 is a diagram showing specific images with different sizes.

### DETAILED DESCRIPTION OF THE PREFERRED EMBODIMENTS

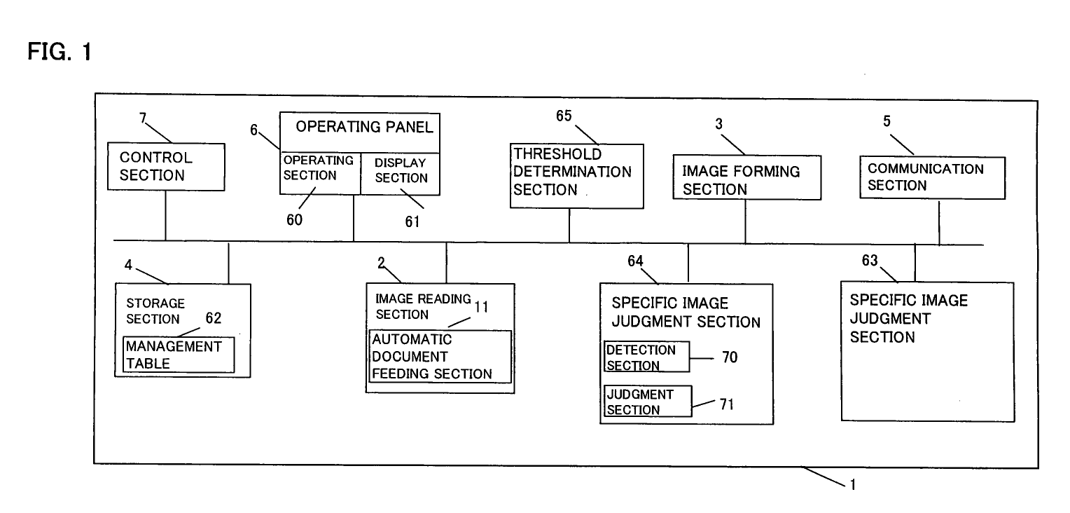

FIG. 1 shows an image processing apparatus of this embodiment. This image processing apparatus is a complex machine which performs a copy mode, a print mode, a scanner mode and a facsimile mode. A cabinet 1 is provided with an image reading section 2 for reading a document and inputting image data, an image forming section 3 for processing and printing image data, a storage section 4 for storing the image data, a communication section 5 for communicating with an external apparatus, an operation panel 6 for performing an input operation, and a control section 7 for controlling a processing section to execute processing of the image data according to the mode. The processing section processes the inputted image data in order to output it, and includes the image forming section 3, the storage section 4 and the communication section 5.

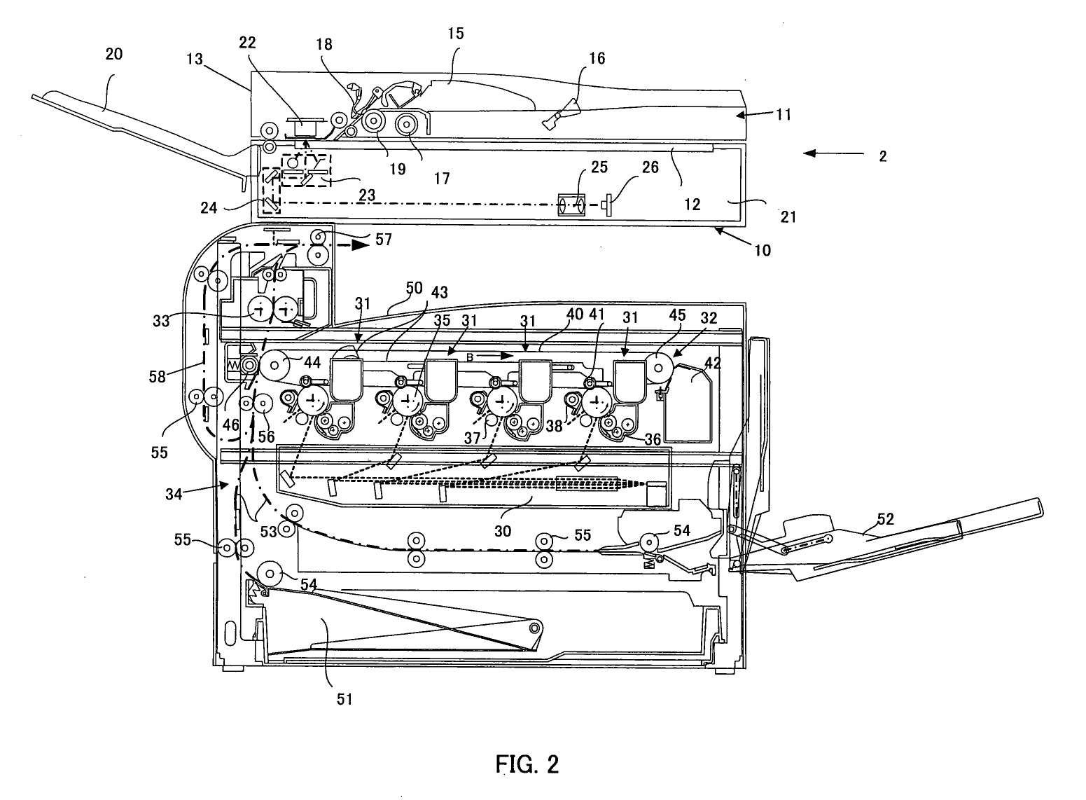

As shown in FIG. 2, the image reading section 2 is arranged above the cabinet 1, and is provided with a scanner section 10 and an automatic document feeding section 11. The automatic document feeding section 11 is arranged above the scanner section 10, and it automatically feeds a document to read the image data of the document.

A document table 12 made of platen glass is provided on the top face of the cabinet 1, and a document cover 13 for covering the document table 12 is also provided. The automatic document feeding section 11 is provided in the document cover 13 being integrated therewith. The document cover 13 can be freely opened and closed. When the document cover 13 is closed, a document is fed by the automatic document feeding section 11. When the document cover 13 is open, a document can be placed on the document table 12. Opening and closing of the document cover 13 is detected by a cover opening/closing sensor. A document size detection sensor for detecting the size of the document placed on the document table 12 is also provided.

When documents are set on a document set tray 15 of the automatic document feeding section 11, a document detection sensor 16 detects that the documents have been set. Then, copy conditions such as the size of a sheet to be printed and a varied magnification are inputted on the operation panel 6. After that, reading of the images on the documents is started by an input operation of a start key.

In the automatic document feeding section 11, the documents on the document set tray 15 are drawn out one by one by a pickup roller 17. The document passes between a stacking plate 18 and a feeding roller 19 and is sent to the document table 12. The document is fed in the vertical scanning direction on the document table 12 and discharged to a document discharge tray 20. The document discharge tray 20 is provided with a document discharge sensor to detect whether there is a document on the document discharge tray 20 or not.

The scanner section 10 is provided with a first reading section 21 and a second reading section 22. A reading area is formed on one side of the document table 12. A document passes through the reading area when fed on the document table 12. A first scanning unit 23 of the first reading section 21 is positioned below the reading area so that the front face (the underside surface) of the document is read.

When the document is fed to the document table 12 by the automatic document feeding section 11, the first scanning unit 23 is moved to a reading position and positioned, and a second scanning unit 24 is also positioned at a predetermined position. The front face of the document is illuminated from below the document table 12 by an exposure lamp of the first scanning unit 23. The light reflected from the document is led to an imaging lens 25 by each of reflecting mirrors of the first and second scanning units 23 and 24. The light reflected from the document is collected on a CCD 26 by the imaging lens 25. The image on the front face of the document is formed on the CCD 26. Thus, the image on the front face of the fed document is read.

The backside (upside surface) of the document is read by the second reading section 22. The second reading section 22 is arranged above the document table 12, and it is provided with an exposure lamp array including LEDs, fluorescent lamps or the like for illuminating the backside of a document, a SELFOC lens array for collecting light reflected from the document for each pixel, a contact image sensor (CIS) for photoelectrically converting the light reflected from the document, which has been received through the SELFOC lens array and outputting an analog image signal, and the like. Thereby, the image on the backside of the fed document is read.

When the document is placed on the document table 12, the image on the front face of the document is read by the first reading section 21. The first and second scanning units 23 and 24 move in the vertical scanning direction while mutually keeping predetermined speed relationship. The document on the document table 12 is exposed by the first scanning unit 23, and the light reflected from the document is led to the imaging lens 25 by the first and second scanning units 23 and 24. The image on the document is formed on the CCD 26 by the imaging lens 25.

When the image on one side or the images on both sides of the document are read in this way, the image data on one or both sides of the document is inputted to the control section 7. The control section 7 has an image data processing section and performs various image processings of the image data by the image data processing section. This image data is outputted to the image forming section 3.

The image forming section 3 prints a color image or a black-and-white image on a sheet on the basis of the inputted image data. The image forming section 3 is provided with a laser scanning unit 30, four image stations 31, an intermediate transfer belt unit 32, a fixing apparatus 33 and a feeding apparatus 34.

Each of the image stations 31 forms a color image corresponding to each of the colors of black, cyan, magenta and yellow. Each of the image stations 31 is provided with a photoreceptor drum 35, a development apparatus 36, a charging apparatus 37, a cleaning apparatus 38 and a neutralization apparatus (not shown).

The photoreceptor drum 35 is rotatingly driven in one direction. The cleaning apparatus 38 cleans residual toner on the surface of the photoreceptor drum 35. The neutralization apparatus removes electricity from the surface of the photoreceptor drum 35. The charging apparatus 37 uniformly charges the surface of the photoreceptor drum 35.

The laser scanning unit 30 modulates a laser beam on the basis of the image data inputted from the image reading section and the like, and repeatedly scans the surface of the photoreceptor drum 35 with this laser beam in the main scanning direction to form an electrostatic latent image on the surface of the photoreceptor drum 35. The development apparatus 36 supplies toner to the surface of the photoreceptor drum 35 and develops the electrostatic latent image to form a toner image on the surface of the photoreceptor drum 35.

The intermediate transfer belt unit 32 is provided with an intermediate transfer belt 40, intermediate transfer rollers 41, a transfer belt cleaning apparatus 42 and a tension mechanism 43. The intermediate transfer belt 40 is arranged above each photoreceptor drum 35 and wound around a driving roller 44 and a driven roller 45 so that it rotates in the direction of an arrow B.

The intermediate transfer roller 41 is arranged so that it faces the photoreceptor drum 35 with the intermediate transfer belt 40 between them, and a transfer bias voltage is applied thereto. By a voltage with a polarity reverse to that of the toner being applied by the intermediate transfer roller 41, the toner image on the surface of the photoreceptor drum 35 is transferred to the intermediate transfer belt 40. The toner images in the respective colors are laminated on the intermediate transfer belt 40, and a synthesized multicolor toner image is formed.

The transfer roller 41 is arranged being pressed to the intermediate transfer belt 40, and a voltage with a polarity reverse to that of the toner is applied thereto. The toner image on the intermediate transfer belt 40 is transferred onto a sheet fed between a transfer roller 46 and the intermediate transfer belt 40, by the transfer roller 46. The toner remaining on the intermediate transfer belt 40 is removed by the transfer belt cleaning apparatus 42.

The toner image transferred to the sheet is fixed on the sheet by being heated and pressurized by the fixing apparatus 33, and the image is formed on the sheet. The sheet on which the image has been printed in this way is discharged to a discharge tray 50 provided on the upper part of the cabinet 1.

The feeding apparatus 34 feeds the sheet along a paper path 53 from a sheet cassette 51 or a manual tray 52. The paper path 53 passes between the intermediate transfer belt 40 and the transfer roller 46 and through the fixing apparatus 33 and leads to the discharge tray 50.

The feeding apparatus 34 is provided with a pickup roller 54, a feeding roller 55, a resist roller 56 and a discharge roller 57. The sheets in the sheet cassette 51 or the manual tray 52 are fed to the paper path 53 one by one, fed along the paper path 53 and discharged to the discharge tray 50. While the sheets are fed, an image is printed thereon. A switchback path 58 is also provided to enable both-side printing. The sheet after fixation is fed into between the intermediate transfer belt 40 and the transfer roller 46, through the switchback path 58 by the feeding roller 55. The both-side printed sheet passes through the fixing apparatus 33 and discharged to the discharge tray 50.

The operation panel 6 is provided for the scanner section 10, and it has an operating section 60 and a display section 61. The operating section 60 includes various operation keys. The display section 61 is configured by a liquid crystal display, and it is a touch panel. Touch keys are formed in an operation screen displayed in the display section 61, and they also function as operation keys.

The communication section 5 is provided with a communication interface, which is connected to a network such as a LAN or a WAN. To the network, multiple external apparatuses are connected. The external apparatuses are other image processing apparatuses, information processing apparatuses such as personal computers, and servers. The network is connected to the Internet from a router via a communication line such as a telephone line and an optical fiber. The communication section 5 is capable of communicating with the external apparatuses via the network, with the use of a predetermined communication protocol. The image processing apparatuses are also capable of communicating with one another. The communication inside the network may be either wired or wireless. An image processing system is formed by these image processing apparatuses and external apparatuses.

The communication section 5 is also provided with a modem apparatus. A telephone line is connected to the modem apparatus. The image processing apparatus can perform facsimile communication. The image processing apparatus can also perform data communication by Internet facsimile through the network. The communication section 5 is further provided with communication terminals and a communication card for wireless communication. Storage media such as a USB memory and an IC card are connected to the communication terminals, and the communication section 5 transmits and receives data to and from the storage media. The communication section 5 also transmits and receives data to and from a communication terminal such as a mobile phone and a PDA by wireless communication via the communication card.

The storage section 4 is configured by a hard disk apparatus. The storage section 4 stores image data inputted from the image reading section 2 or the communication section 5. The inputted image data is once stored in an image memory such as a DRAM, undergoes image processing and encryption processing and then transferred to the storage section 4 from the image memory. When the image data is read from the storage section 4, the image data undergoes image processing and decryption processing and then stored in the image memory. After that, the image data is outputted to the outside by printing, data communication or facsimile communication according to the executed processing.

The storage section 4 has a management table 62. In the management table 62, information required for operating the image processing apparatus, such as control information and setting information for the image processing apparatus and authentication information about a user, is stored. If such information is created or changed, the information in the management table 62 is updated. The management table 62 may be provided for a nonvolatile memory different from the storage section 4.

The control section 7 is configured by a microcomputer having a CPU, a ROM and a RAM. The CPU reads a control program stored in the ROM onto the RAM and executes the control program. Each section operates in accordance with the control program. If image data is inputted, one of the print mode, the copy mode, the scanner mode and the facsimile mode is executed on the basis of processing conditions included in input information from the operating section 60 or header information of the image data inputted from the external apparatus. Furthermore, the control program includes a browser and mail software so that the control section 7 performs data communication with external apparatuses, and transmits and receives e-mails from the external apparatus, with the use of communication protocols such as the TCP/IP protocols.

The control section 7 temporarily stores the inputted image data in the storage section 4 when performing each mode. The control section 7 also executes a filing mode for storing inputted image data in the storage section 4 and managing it. The stored image data is outputted again in accordance with specified processing.

The outputted image data is erased from the storage section 4 in response to an instruction from the control section 7. When being erased, the image data is invalidated so that it cannot be restored, by overwriting random data on the image data. Thus, by performing the invalidation processing and further performing encryption processing, unauthorized use of the image data is prevented.

In order to prevent a confidential document from being unauthorizedly copied or facsimile-transmitted, specific images are added to the document. The specific image represents restraint information for restricting the processing to be executed, such as inhibition of copying, degradation of printed image quality, inhibition of data transmission and facsimile transmission and inhibition of filing.

The image processing apparatus is provided with a specific image adding section 63 which adds the specific images, a specific image judgment section 64 which detects the specific images in inputted image data and judges whether the specific images are included on the basis of a threshold, and a threshold determination section 65 which determines the threshold.

The operation of the specific image adding section 63 is controlled by the control section 7, and the specific image adding section 63 generates specific images on the basis of determined addition conditions and synthesizes the specific images with inputted image data. The addition conditions for the specific images are stored in the management table 62. The addition conditions include the form, the image forming conditions, the number, the positions and the like of the specific images. The control section 7 performs processings such as printing, data transmission and filing of the synthesized image data.

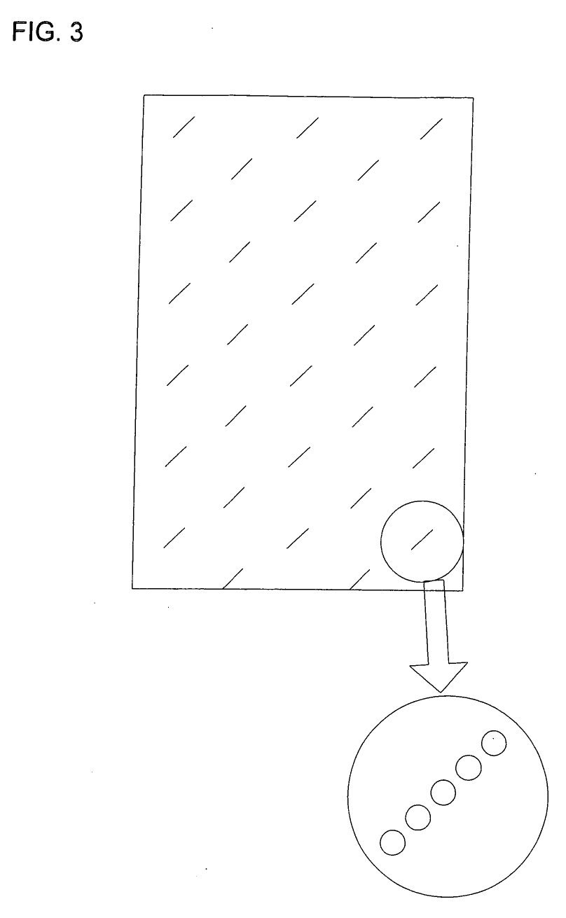

When the image data with the specific images added is printed, a document including the specific images as shown in FIG. 3 is created. The specific image is an image having a predetermined form. That is, the specific image is an inclined pattern in which multiple dots are linearly arranged. Specific images in the same form are regularly arranged at predetermined positions. One document page includes multiple specific images. The number of specific images per one page is determined in accordance with the page size. The density, the dot size and the pattern angle of the specific image are also determined.

Data transmission of the image data including the specific images is performed via the communication section 5. When the image processing apparatus which has received this image data prints the image data, a document including the specific images is created.

The specific image judgment section 64 detects specific images from inputted image data and determines whether the number of specific images exceeds a threshold. The operation of the specific image judgment section 64 is controlled by the control section 7, and the specific image judgment section 64 has the functions as a detection section 70 for detecting specific images in image data and a judgment section 71 for judging whether or not the number of detected specific images exceeds a threshold.

The detection section 70 detects a specific image by performing pattern matching between the inputted image data and image data corresponding to specific images. The image data corresponding to specific images are recorded and stored in the management table 62 in advance. The image data is not limited to image data inputted from the image reading section 2. It may be inputted from an external apparatus through the communication section 5, or from a storage medium or a communication terminal.

The judgment section 71 counts the number of detected specific images and judges whether or not the number of detected specific images exceeds a threshold. When the image data is created in pages, the number of specific images is calculated for each page. Alternatively, the number of specific images within a predetermined area size is calculated.

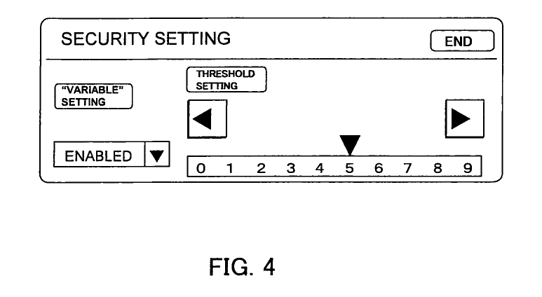

The threshold determination section 65 stores a threshold set by an authorized user such as an administrator, in the management table 62. The authorized user is authenticated by inputting authentication information, for example, a password and biometric information such as a fingerprint. The authenticated user can set a threshold on the security setting screen shown in FIG. 4. When the user specifies a security level, a threshold is determined according to security levels 0 to 9. As the number is larger, the security level is higher, and the threshold is lower. When the security level is low, the threshold increases. Specific values of the threshold are determined according to page sizes and stored in the management table 62. On the basis of size information about the image data, the specific image judgment section 64 reads a threshold corresponding to the specified size from the management table.

When the number of specific images included in the inputted image data exceeds the threshold, the judgment section 71 judges that specific images are included. The control section 7 restricts the processing to be executed. That is, the control section 7 instructs inhibition of copying in the case of the copy mode, and instructs inhibition of transmission in the case of the facsimile mode or the scanner mode. In the case of the filing mode, the control section 7 instructs inhibition of storage of the image data into the storage section 4.

Even if specific images are detected, the judgment section 71 judges that specific images are not included if the number of specific images does not exceed the threshold. The control section 7 does not restrict processing.

Specific images are added to image data. Image data may include similar images which are similar to specific images, such as ruled lines, underlines and oblique lines. Furthermore, similar images may also exist in the ground or ground pattern of a document on which the image data is printed. Such similar images are read by the image reading section 2. The existence of the similar images may be a factor of misjudgment.

Accordingly, in order to enhance the accuracy of specific image judgment and eliminate misjudgment, the characteristics of a specific image can be changed according to the importance degree of the specific image when the specific images is added. The specific image is characterized by three elements of angle, density and size. The specific image is a predetermined form in which multiple dots are arranged in a predetermined pattern. The angle of the linearly arranged pattern is the angle of the specific image. The density of the dot constituting the specific image is the density of the specific image. The size of the dot is the size of the specific image. The importance degree is determined according to the degree of restriction of processing, and it corresponds to the security level. When the importance degree is high, the security level is raised. When the importance degree is low, the security level is lowered.

The specific image adding section 63 sets addition conditions in accordance with the determined importance degree. As the addition conditions, an addition condition for each of the elements of angle, density and size is set. Then, the specific image adding section 63 determines the characteristics of the specific image to be added, on the basis of the addition conditions. That is, each of the elements of angle, density and size is changed according to the determined importance degree of the specific image and the specific image is characterized.

In this way, the importance degree is decided by setting the security level, and at the same time, the angle, the density and the size are determined. The form of the specific image to be added is finally determined on the basis of these characteristics.

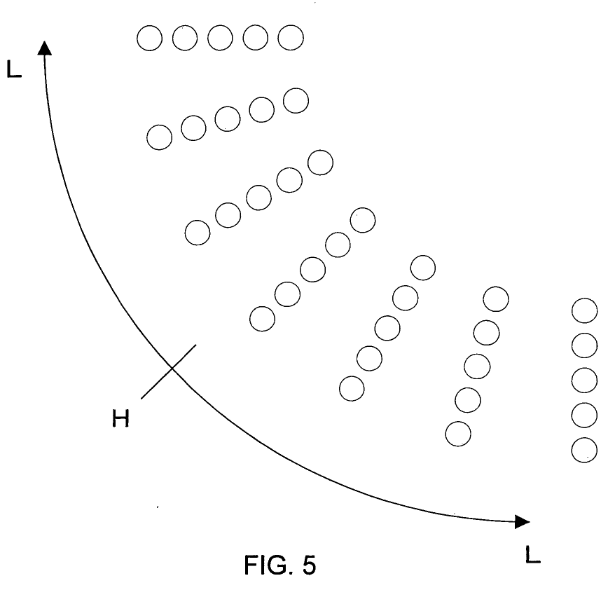

Specifically, as for the angle, an angle between 0 to 90 degrees is set as shown in FIG. 5. The angle of 45 degrees indicates the highest importance degree. As the angle is closer to 0 or 90 degrees, the importance degree is lower. When the angle of the specific image is close to 0 degree, it may overlap with or resemble a horizontal line image such as an underline or a ruled line. When the angle of the specific image is close to 90 degree, it may similarly overlap with or resemble a vertical line image. As the angle is away from 45 degree, it becomes difficult to accurately detect the specific image. That is, the importance degree lowers.

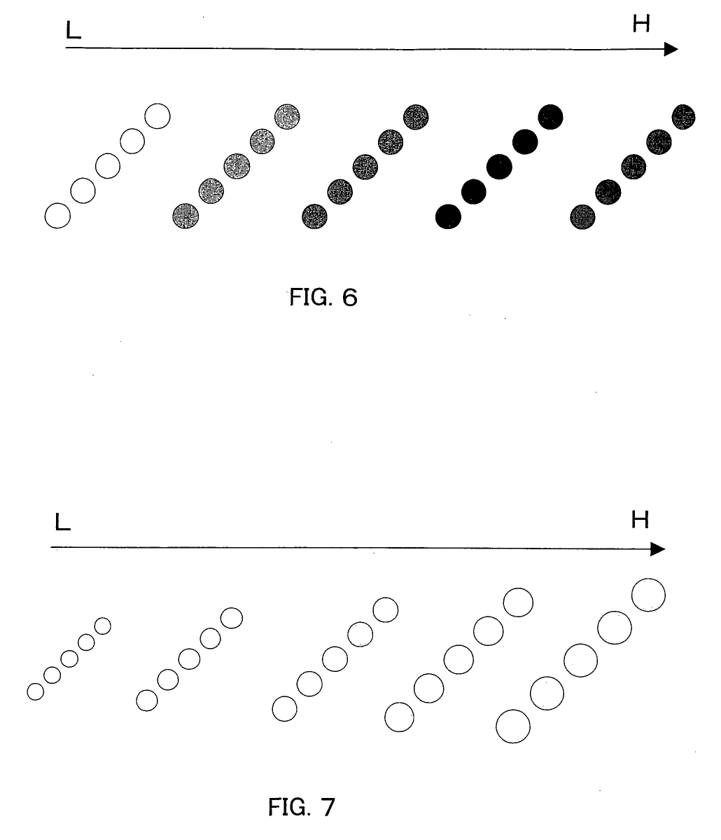

As for the density, the density is set higher as the importance degree is higher, and it is set lower as the importance degree is lower, as shown in FIG. 6. When the density of the specific image is low, the image is light and difficult to distinguish from other images. That is, the accuracy of detecting the specific image lowers, and the importance degree also lowers.

As for the size, the dot is set larger as the importance degree is higher, and it is set smaller as the importance degree is lower, as shown in FIG. 7. The size of the whole specific image is larger as the importance degree is higher. When the dot of the specific image become small, interference with images around it is caused, and the specific image cannot be accurately detected. Therefore, the importance degree lowers.

When the characteristics of the specific image is determined, changes in the three elements are combined, changes in two of the elements are combined, or only one element is changed. By combining the elements, it is possible to variously determine the importance degree according to the processing to be executed and restrict only particular processing.

When image data to which the specific image described above is added is inputted to the image processing apparatus, in the copy mode or the print mode, the specific image judgment section 64 judges whether or not specific images are included in the image data, on the basis of a threshold. In this case, the threshold determination section 65 recognizes the characteristics of the detected specific image and determines a threshold according to the characteristics.

That is, when detecting a specific image, the detection section 70 identifies its characteristics. Specifically, it extracts an image having a predetermined form, judges that the image is a specific image, and then identifies each of the elements of the angle, density and size of the specific image. By recognizing the characteristics of the specific image, the threshold determination section 65 identifies the importance degree and judges the security level from the importance degree. Then, it determines a threshold on the basis of the security level. Accordingly, when the importance degree of the detected specific image is high, a small value is determined as the threshold, and when the importance degree is low, a large value is determined as the threshold.

The judgment section 71 counts the number of specific images and judges whether or not the number of specific images exceeds the threshold. The control section 7 restricts the processing to be executed when the number of specific images included in the inputted image data exceeds the threshold. That is, the control section 7 instructs inhibition of copying in the case of the copy mode, and instructs inhibition of transmission in the case of the facsimile mode or the scanner mode. In the case of the filing mode, the control section 7 instructs inhibition of storage of the image data in the storage section 4. Even if a specific image is detected, the control section 7 does not restrict the processing if the number of specific images does not exceed the threshold.

The specific image with a high importance degree is characterized so that similar images are reduced. Therefore, the specific image can be detected without fail, and misdetection is eliminated. Furthermore, since a small value is determined as the threshold, judgment about whether or not specific images are included can be performed, and the accuracy of the judgment is improved.

On the other hand, in the case of the specific image with a low importance degree, similar images increase. Therefore, in detecting specific images, misdetection that a similar image is detected as a specific image increases. However, since a large value is determined as the threshold, judgment about whether or not specific images are included can be correctly performed, and the judgment accuracy can be kept without deterioration.

In the above description, when the threshold is not set in advance, it is determined on the basis of the characteristics of the specific image. When the threshold is set in advance, the threshold determination section 65 changes the set threshold according to the characteristics of the detected specific image to determine a threshold.

When the security level is set on the security setting screen shown in FIG. 4, a threshold is set. In order to make the threshold changeable, “variable” setting is enabled. If the “variable” setting is disabled, the threshold cannot be changed and is kept constant. By setting the security level, the importance degree of the specific image is decided, and the characteristics of the specific image are determined. Thus, a reference specific image is obtained.

The threshold determination section 65 changes the threshold on the basis of the degree of change in the characteristics of a detected specific image relative to the characteristics of the reference specific image. That is, each elements of the detected specific image is compared with each element of the reference specific images. Since each element is determined in stages according to security levels, the differences between the security levels of the detected elements and the security levels of the reference elements are calculated. The security level difference is calculated for each element, and the change degree is determined from the three differences. As the security level difference is large, the change degree is also large.

Then, the threshold determination section 65 changes the reference threshold according to the change degree. When the change degree is large, the threshold is changed much. When the change degree is small, the threshold is changed little. When the change degree is the degree of plus change, that is, when the security level of the detected specific images is higher than the security level of the reference specific image, the threshold is lowered, and a value lower than the reference threshold is set. On the contrary, when the change degree is the degree of minus change, that is, when the security level of the detected specific images is lower than the security level of the reference specific image, the threshold is increased, and a value higher than the reference threshold is set.

The judgment section 71 judges whether or not specific images are included on the basis of the changed threshold. The control section 7 restricts or does not restrict the processing to be executed on the basis of the judgment result.

As described above, specific images characterized according to the importance degree are added to image data in an image processing apparatus. When this image data is inputted to a different image processing apparatus, a threshold corresponding to the importance degree of the specific images is determined by recognizing the characteristics of the specific images. Thus, it is possible to perform specific image judgment in consideration of the importance degree of the specific images. It is possible not only to accurately judge the existence of specific images when the importance degree is high but also to judge the existence of specific images without being influenced by similar images even when the importance degree is low. Thereby, it is possible to improve the accuracy of specific image judgment and prevent misjudgment.

The present invention is not limited to the above embodiments. It goes without saying that a lot of modification and changes can be made in the above embodiments within the scope of the present invention. The form of the specific images is not limited to the form in which they are inclined and face toward a certain direction. A form in which the specific images have irregular patterns, a character image such as “copying inhibited” and “confidential”, and a form in which a character and a pattern are combined are also possible. In the case of a specific image including such a character image, the specific image is characterized by the density and the size. Furthermore, the specific image may be characterized by the position of addition. The distance from a predetermined position differs according to the importance degree. The threshold may be not a numeric value but a ratio of the area of the specific images to one page. As the threshold, the area ratio is determined lower as the importance degree is higher, and it is determined higher as the importance degree is lower.

What is claimed is:

1. An image processing apparatus comprising:
a detection section for detecting a specific image in inputted image data;
a judgment section for judging whether the specific image is included in the image data on the basis of a threshold;
a threshold determination section for recognizing the characteristics of the detected specific image and determining the threshold according to the characteristics.

2. The image processing apparatus according to claim 1, wherein the characteristics of the specific image are changed according to the importance degree of the specific image.

3. The image processing apparatus according to claim 2, wherein the specific image is in a form having a predetermined angle, and the specific image is characterized by changing the angle.

4. The image processing apparatus according to claim 2, wherein the specific image is in a form having a predetermined size, and the specific image is characterized by changing the size.

5. The image processing apparatus according to claim 2, wherein the specific image is in a form having a predetermined density, and the specific image is characterized by changing the density.

6. The image processing apparatus according to claim 1, wherein the threshold determination section changes the threshold on the basis of the degree of change in the characteristics of the detected specific image relative to the characteristics of a reference specific image.

7. The image processing apparatus according to claim 2, wherein the threshold determination section changes the threshold on the basis of the degree of change in the characteristics of the detected specific image relative to the characteristics of a reference specific image.

8. The image processing apparatus according to claim 6, wherein the threshold is the number of specific images; the threshold is set smaller as the importance degree of the specific image is higher; and the threshold is set larger as the importance degree of the specific image is lower.

9. The image processing apparatus according to claim 7, wherein the threshold is the number of specific images; the threshold is set smaller as the importance degree of the specific image is higher; and the threshold is set larger as the importance degree of the specific image is lower.

10. The image processing apparatus according to claim 8, wherein the threshold determination section increases or decreases the set threshold on the basis of the degree of change in the characteristics of the specific image.

11. The image processing apparatus according to claim 9, wherein the threshold determination section increases or decreases the set threshold on the basis of the degree of change in the characteristics of the specific image.
